(19) United States
(12) Patent Application Publication
(10) Pub. No.: US 2010/0088623 A1
(43) Pub. Date: Apr. 8, 2010

(54) OPERATIONAL SUPPORT COMPUTER PROGRAM AND OPERATIONAL ASSITANCE COMPUTER SYSTEM

(75) Inventor: Kenichi Ichino, Tokyo (JP)

Correspondence Address: APEX JURIS, PLLC, 12733 LAKE CITY WAY NORTHEAST, SEATTLE, WA, 98125, US

(73) Assignee: Core Aplli Incorporated, Tokyo (JP)

(21) Appl. No.: 12/445,450

(22) PCT Filed: Oct. 13, 2006
(86) PCT No.: PCT/JP2006/320513

§ 371 Date: Apr. 13, 2009

(51) Int. Cl. G06F 3/048

(52) U.S. Cl. 715/766; 715/802; 715/794

(57) ABSTRACT

It is an object to provide an operational support computer program and an operational support computer system that carry out a simple and convenient input operation by means of an input button, such as a keyboard or the like.

An operational support computer program makes a processing means execute (1) receiving a command to change an input focus status of an operation subject information and/or an operation subject scope, (2) changing an input focus status as a part of the operation subject scope information and/or an operation subject scope and also changing display of an object to be displayed in a display area of an output means, (3) selecting an object that has a higher priority in the display ranking than the object with the input focus and judging whether or not there is an overlapped area between the operation subject scope and the display area of the selected object, (4) with a result of judgment (3), changing a display method of the object for not obstructing the display of an operation subject scope of the object, which has an input focus, on the monitor of the output means, if there are any applicable objects as a result of (3), and (5) terminating the operation of display change stated in (4), in the case that processes (1) and (2) result in overcoming of the state (3).

### FIELD OF THE INVENTION

The present invention relates to a computer program which facilitates users' data input into a computer system using input devices such as keyboards and mouse devices. More particularly, this invention relates to an operational support technique for helping to control a display as appropriately changing the windows display style while running a software that adopts the multi-window interface.

### BACKGROUND OF THE INVENTION

The multi-window interface with a graphic user interface (hereinforth, referred to as a “GUI”) is capable of displaying multiple windows and can run multiple computer programs and data simultaneously. Under such interface, multiple windows are generally displayed during an operation, and when selecting one of displayed windows, input devices such as a mouse device or like are used.

When windows overlap each others, a window of high priority in a display ranking is shown on a monitor display, alternatively, that of low priority is not shown on a monitor display. This forces users to go through inconvenience procedure, when users intend to select a window of a lower priority.

Similarly, a toolbar window is normally set as a window of a higher priority in the display ranking than a tool bar window, and therefore this causes a main window blocked by the toolbar window when users intend to select data displayed in the main window as an operation subject.

### CROSS REFERENCES TO RELATED APPLICATIONS

The patent references 1 and 2 listed below disclosed the technique related to the display and operation of a window.

[Patent Reference 1] Japanese Unexamined Patent Application No. 2002-278746

[Patent Reference 2] Japanese Patent Laid-Open Publication No. 08-161141

### DISCLOSURE OF THE INVENTION

The problems to be resolved by this invention are mainly for a software for multi-window system to prevent unnecessary windows from blocking necessary windows by changing a display of unnecessary windows. An object of this invention is to provide a method that a software judges unnecessary windows and changes their display method while users perform a usual operation.

### 1. First Feature

<A> The computer program related to the present invention including an information storage means, information processing means, output means which displays information to users, and input means that accepts commands from users operates as an operational support computer program when aforesaid output means displays multiple objects in a display area while users perform the operation on one of aforementioned objects with an input focus.

The storage means of the operation computer system memorizes operation subject scope information, which presents a display range of an operation subject of the processing means on a display area on a monitor display by corresponding an object ID to an input focus status and an operation subject scope, display range information which presents a display range on a display area of the output means by corresponding an object ID to a display range, display ranking information which indicates a priority ranking of the displayed object on the display area of the output means, and display change method information which describes a method how to change the display of a object shown in the display area by corresponding an object ID to a display change method.

The operational support computer system features in (1) receiving a command, which is given by the input means, that changes the input focus status and/or the operation subject scope, which is a part of the operation subject range information stored in the storage means,

(2) changing the input focus status and/or the operation subject scope, which are stored in the storage means as a part of the operation subject scope information, based on the command received, subsequently, changing the display ranking, a part of display ranking information, which changes the display of objects presented in the display area when the input focus status has been changed,

(3) selecting an object which is higher in the display ranking than that has the input focus, based on the operation subject scope information and the display ranking information, and judging whether or not there is an area which an operation subject scope of an object with the input focus overlaps with a display range of the selected object based on the display change method information and the display range information,

(4) not obstructing the display of the operation subject scope of the object, which has an input focus, on the display area of the output means by changing the display method of the object based on the display change method data, if there are any applicable objects as a result of (3), and (5) terminating the operation of display change stated in (4), when the process of (1) and (2) operation have solved the state (3).

<B> The term “storage means” includes memory storage devices such as RAM, ROM, HDD or the like. A specific example of “processing means” includes processing unites, such as CPU, and a main server computer which is located on a computer system linked to a communication network. “Output means” includes an output device, such as computer monitor that presents information of the computer system, and a communication terminal linked to a communication network, such as a cellular telephone and a personal computer. “Input means” includes input devices, such as a keyboard, mouse pointer, touch panel, and a communication terminal linked to the communication network, such as a cellular telephone and a personal computer.

The constituent of “operational support computer system” can be either one hardware belonging to a personal computer or multiple computers. In one specific example of multiple computers composing a “process support computer system”, a CPU may function as “processing means”, a storage device administrated by a main server computer may be “storage means”, an information terminal communicating with a CPU (such as cellular phones and personal computers) maybe “output means” and “input means”.

“Display area of output means” shall mean a display area on the output devices that presents information, such as monitors allocated for images and text data. “Input focus” is a term that means a window receiving input data under a multi-window interface. “Object” indicates a block of displayed image, such as windows, gadgets, icons, images and mascot pictures of help functions presented by an operation software (OS) and an application software within the display area of output means. An example of window is a parent window (or main window; a window that displays data which are operation subject) and a subwindow (or an auxiliary window that supports users' operation such as a toolbar and a pallet window)

“Object ID” is information consisting of numbers and symbols that specify each object. “Input focus status” is information indicates whether or not each object has an input focus. “Display range” is information specifying the display range (pixel range) of each object presented in a display area of the output means. When “display range” of several objects overlap, an object which has higher in “display ranking” will be given a priority in presenting on the display area of the output means. “Operation subject scope” is information that indicates a display range (pixel range) of an operation subject that occupies out of the display range of its object, which has an input focus, on the display area of the output means. As a specific example of “operation subject scope”, in a word-processing application software, may be two character spaces which include one character space for both sides of a cursor location, one character space which is at the right hand side next to the cursor location, selected multiple character spaces, spaces around a mouse pointer when a selected data is in the process of relocation by drag-and-drop. Another specific example of “operation subject scope” in a spreadsheet application software can be an area for a selected cell, area for multiple selected cells, area around a mouse pointer when selected cells are in the process of relocation. Note, when the process of the relocation data, such as drag-and-drop, that the “operation subject scope” may either be restricted to a display range for an object that has an input focus or to a display range for an operation subject scope. “Display ranking” is information of a ranking that determines which object should be given a priority in being displayed on the display area of the output means when a display range of multiple objects overlap each other. “Display change method” is information that changes a display method of objects from the normal state presented on the display area of the output means. More specifically, this is a program that shifts the display method of an object in order not to be overlapped with the display of the operation subject scope presented on the display area.

“A command that changes the input focus status and/or the operation subject scope” includes a command that passes an input focus from one object to another and a command that changes a scope of the operation subject within an object that has the input focus scope. “Changing the display ranking, a part of display ranking information, which changes the display of objects presented in the display area when an input focus status has been changed” means changing of display ranking of each object in order to give a priority to an object that holds the input focus so that this particular object can have an operation subject. As a more specific example of changing method of the display ranking, the display ranking of sub-windows (e.g. tool windows) are always set as high in opposed to the display ranking of a parent window which flexibly shifts. Another specific example of the method of changing the display ranking is setting an object which holds the input focus the highest in the display ranking, then, the following ranking corresponds to the temporal length of which each object an input focus has hold within a period of time between a specific past time and the time of the current process. Another specific instance of changing the display ranking is setting an object with the input focus the highest in the display ranking, and the rest corresponds to the temporal recentness between the time of the present process and the time when each object most recently had the input focus.

“Selecting an object which is higher in the display ranking than that has an input focus, based on the operation subject scope information and the display ranking information, and judging whether or not there is an area which an operation subject scope of an object with the input focus overlaps with a display range of the selected object based on the display change method information and the display range information” means judging whether or not there are objects both ranked higher in the display ranking than an object with an input focus and of which a display range overlaps with a operation subject scope. “Not obstructing the display of an operation subject scope of the object, which has an input focus, on the monitor of the output means by changing the display method of the object” may mean facilitating a display of the operation subject scope that belongs to an object which has the input focus. Specific examples of means of changing the display method of the object may be changing the display of the object either into paler or transparent, or not displaying the object temporally. “Terminating an operation of display change stated in (4), when the process of (1) and (2) operation have solved the state (3)” means that a display returns into a normal, when the state (3) has resolved as a result of a change occurred by the operation described in (1) and (2), such as a change in a display ranking or a change in an operation subject scope.

<C> Features that when the operation subject scope of an object with the input focus is overlapped by a display of other objects, the display method of the object changes appropriately without users' explicit command. This change prevents the display of the operation subject scope of an object with the input focus from being obstructed. Another feature is that a change in the input focus status and in the content of the operation subject scope do not affect the display of the operation subject scope which has an input focus. Furthermore, when the change is not required any longer to display an operation subject scope, a display which has been changed returns back to the state before the change has been made without any explicit commands of users. Specific examples of these are an object which used to overlap with an object with an input focus does no longer overlap with the operation subject scope, or where the object with the input focus has became rated higher in the display ranking.

These operation provide users a easier solution because users do not have to perform any operations to display the operation subject scope even when the display of the operation subject scope of the object with the input focus is blocked under the multi-window interfaces. Moreover, the display goes back to the normal state automatically, when the operation subject scope of the object with the input focus is no longer blocked. Additional features and advantages are described herein, and will be apparent form, the following Detailed Description and the figures.

### 2. Second Feature

<A> Addition to the stated institution, another invention is the storage means memorizes a display change method information, which shows how to move a location of a display range of an object presented on a display area, by corresponding an object ID to a display change method.

Additionally, (4) this operational support computer system avoids the blockage of a display of the object with an input focus on the display area of the output means. More specifically, when there is an object applicable to (3), based on the display change method information, the display range of the object on the display area will be relocated in order to avoid an overlap between an object and an object with the input focus.

<B> Here, “a display change method information, which shows how to move a location of a display range of an object presented on a display monitor” means information that specifies an object of which display range to be moved and determines where to move by corresponding an object ID to a display change method that commands to change a location of an object. “The display range of the object on the display area will be relocated in order to avoid an overlap between the object and an object with the input focus” means that moving a location of the display range of the object on a monitor of the output means in order to avoid an obstruct a display of an object which has an input focus. A specific example of “relocating a display range of an object” can be moving the object either upward or downward (along Y-axis direction), moving the object rightward or leftward (X-axis direction), or diagonally (along both X and Y axis direction) from the normal state. “Display change method” includes a command that moves a location of an object in relation to the display range of its normal location.

<C> The present invention has a feature that a display of an operation subject scope on an object that has an input focus is not obstructed because a display of other objects that overlap with the object that has an input focus move appropriately without users' explicit commands. Furthermore, the display of the object which was changed returns back to the original state, when the change is not required any longer to display the object which has an object that has an input focus. Specific examples of this situation are an object which used to overlap with the object with the input focus does no longer overlap with the operation subject scope, or the object with the input focus has became rated higher in the display ranking.

This provides users easier solution because users do not have to perform any operations to display the operation subject scope even when the display of the operation subject scope of the object with the input focus is blocked under the multi-window interfaces. Furthermore, the program enables the display of an object which has been relocated to be stayed shown. That is, users are able to refer to an object of which display range has been relocated while performing an operation to the operation subject scope of an object that has an input focus, which leads a smooth operation to users.

### 3. Third Feature

<A> Also, in another aspect of this invention, in addition to the above-identified structures, this computer support system memorizes a display change method information that allows contents of an object ranked lower in the display ranking to be presented by changing a display of an object which is at the front of the display into transparent based on the correspondence between an object ID and the display change method.

Additionally, the preset invention of an operational support computer program has a feature that (4) changing the display of an applicable object, as a result of (3), if any, into transparent based on the display change method information, which avoids an obstruction of the display of operation subject scope of the object, which has an input focus, on the display area of the output means.

“Display change method information that allows contents of an object ranked lower in the display ranking to be presented by changing a display of an object which is at the front of the display into transparent” indicates information that specifies an object to be changed into transparent and how the object to be changed in to transparent. “Changing the display of an applicable object in transparent based on the display change method information, which avoids an obstruction of the display of operation subject scope of the object, which has an input focus, on the monitor of the output means” means that changing the display of an object from its original color, which is non-transparent, to the transparent in order not to block the display of the object which has an input focus. As a specific example of “changing the display of object into transparent” is making colors of an object into faint so that an object that are ranked lower in the display ranking can be visible to users. “Display change method” includes a command that changes the display of an object into the transparent.

(3) The present invention has a feature that a display of an operation subject scope on the object that has an input focus is not obstructed because a display of an object that overlaps with the object with an input focus becomes transparent without users' explicit commands.

Thus, this provides users easier solution because users do not have to perform any operations to display the operation subject scope even when the display of the operation subject scope of the object with the input focus is blocked under the multi-window interface. Furthermore, the program enables the content of display of an object to be viewed from users. That is, users are able to refer to an object of which display range has been changed into transparent while performing an operation to the operation subject scope of an object that has an input focus.

### 4. Forth Feature

<A> Addition to the stated institution, another invention is the storage means memorizes display change method information, which shows both how to move a location of a display range of an object presented on the display area of the output means and information of a display range of an object which has been relocated in order to present an object ranked lower in the display ranking. These are operated by corresponding a display change method to each of an object ID in the storage means.

Additionally, (4) this operational support computer system avoids the blockage of a display of an object with an input focus on the monitor. More specifically, when there is an object applicable to (3), based on the display change method information, the display range of the object on the display area of the output means will be relocated and information in regards to a display range where the object is used to be displayed before the relocation is presented.

“Display change information, which shows both how to move a location of a display range of an object presented on the display area of the output means and information of a display range of an object which has been relocated in order to present an object ranked lower in the display ranking” is able to specify which and to where the object should be relocated and information regarding a display range of a moved object used to be presented, based on the correspondence between a display change method, which commands a relocation of an object, and each object ID. “Avoiding the blockage of a display of an object with an input focus on the display area of the output means, more specifically, the display range of the object will be relocated and information about a display range where the object is used to be displayed before the relocation is presented” indicates a relocation of the display of an object presented on the output means in order to avoid to block a display of an object, which has an input focus, and displays information that shows a display range where the object used to be displayed before its relocation. “Information that shows a display range where the object used to be displayed” does not obstruct with the display of an operation subject scope of an object that has an input focus. A specific example of “information that shows a display range where the object used to be displayed” is presenting the display range where the object used to be displayed in paler colors.

<C> In the present invention, a display of an operation subject scope on the object that has an input focus is not obstructed because an object that overlaps with the object with an input focus is moved appropriately and simultaneously, the display range where the object used to be displayed is presented. As a result of presenting a display range where the object used to be displayed, users can easily specify the display range where the object will return back after the display of the object moved back to.

Thus, this provides users easier solution because users do not have to perform any operations to display the operation subject scope under the multi-window interface. This invention enables users to easily recognize to which part of display area the pre-moved object will go back to, and therefore it becomes apparent for users how to change the operation subject scope of the object with the input focus in order to bring the post-moved object back to a certain or predetermined position.

### 5. Fifth Feature

<A> Additionally, another invention is the storage means memorizes operation subject information, drop target option information and display change method information, where the operation subject information indicates a display range of data which becomes an operation subject as it contains the operation subject scope; the drop-target-option information allows a user to decide whether or not an object becomes a target object, which is an object to which selected data are passed to, that is possible because a target flag option, which is a set of picture data, object ID, and a target flag correspond each other; and the display change method information indicates a change in the display method of an object which is presented on the display area of the output means.

This invention is an operational support computer program which has a feature that, while a process of moving the selected data which is a part of an object which has an input focus, operations shown as (1)-(4) below will be conducted in the processing means, and when a destination operation on the selected data completes, the display operation (3) also completes.

(1) When the processing means receives a command that changes the operation subject scope via the input means, the processing means changes the operation subject scope of the operation subject scope information in response to the command,

(2) judges whether or not there are any objects whose display range overlaps with the display rage of an operation subject scope. The judgment is made based on the operation subject scope information and the display range information.

(3) An applicable object as a result of the judgment (2), if any, the target flag option will be displayed in the display area of the output means using drop-target option information; when the target flag option is set as off, the display method of the object changes based on the drop target option information and the display change method information, which will disenable to be selected as a target object.

(4) When the target flag option is pointed by a pointer via the input means, the content which is connected to the target flag option will be the content whether or not it is presented by the target flag option.

<B> A “target flag” is information that shows whether or not the corresponding object is a target object to which selected data is passed to. The target flag has two information mode, ON or OFF. ON indicates that an object is set as the target object, and OFF indicates that an object is not set as the target object. “Target object” indicates an object to which selected data are passed to. When “passing the selected data to a target object” the selected data becomes an operation subject. In a specific example, when a toolbar is set as a target object, and multiple selected spaces of text data in the main text data presented in the main window are “selected data set as the operation subject”, the selected text data are passed to the specific tool bar by operating drag-and-drop. A “target flag option” is picture data that is presented on the display area of the output means, which contains two target options, one for ON which turns off the target flag and another for OFF which turns off the target flag.

“During the process of the selected data located at the object with the input focus destination” means that the process of selecting a destination to which the selected data the object with the input focus is under the process will move to. For example, drag operation of “drag-and-drop”, which is exercised as a command for relocating the selected data. However, the “destination operation” is not necessarily restricted to a display range of an object that has an input focus, but the outside of a display range of the object. “When a destination operation on the selected data completes” means that completion of an operation that decides a location to where the selected data, an operation subject scope, are passed, such as, the time when drop operation of drag-and-drop completes. “When a destination operation on the selected data completes, the display operation (3) also completes” indicates an operation that turns off the display of the selected target flag which was made shown by the operation (3).

“Judging whether or not there are any objects whose display range overlaps with the display range of an operation subject scope” means judging whether there is an area where the operation subject scope and the display range of each object. When “a target flag option of an object will be displayed in the display area of the output means using the drop-target option information”, it is preferable to display the target flag option close to the display range of the object. This enables users to recognize the correspondence between the object and the target flag option. “When the target flag option is set as off, the display method of an object changes based on the drop target option information and the display change information, which will disenable to be selected as a target object” means that when the target flag option of the object which has an area that overlaps with the operation subject scope is set as OFF, the display method of the object changes in order not to be selected as a target object. This is because the selection of a user made states that the user does not want the object to be a target object. Specific examples of “the display method of the object changes in order not to be selected as a target object” can be relocating a display of the object in order not to overlap with the operation subject scope or making the display of the object into transparent.

“A target flag option on the display area of an output means is selected by a pointer, an input means” indicates that a location information for a pointer presented on the display area overlaps with the target flag option which is a picture data shown in the display area of the output means as a result of moving a mouse pointer via an input means such as mouse device. An example of “content of the correspondence of the target flag turns into the contents presented on the target flag either on or off following to the selection made by users” is that if information of a target flag option selected by a mouse pointer is ON, the content of the target flag corresponded to the target flag option is turned into ON. Then, when the target flag option selected by a mouse pointer is OFF, the content of target flag connected to the target flag option would turn into OFF.

<C> In the present invention, when the operation subject scope overlaps with a display area of another object during the destination operation of the selected data, a target flag option is displayed in the display area of the output means. That is, the target flag option is changed into, either ON or OFF by a selection made by a pointer. If the target flag changes into OFF, the corresponding object does not become a target option. Therefore, users easily select whether or not an object which has a display area overlapping with the operation subject scope should become a target object.

By doing this, the operation that selects a target object becomes easier, that leads to the efficiency in the destination operation under the multi-window interface. More specifically, this leads convenience to a user as drag-and-drop operation simultaneously triggers the selection of the target object.

### 6. Sixth Feature

<A> Another embodiment of this invention is that this computer operation system has a feature that a storage means memorizes the computer program and/or information stated in a claim 1 or 5, and then, which the processing means presses.

As stated above, with the present invention users do not have to perform any operations to keep the display of the operation subject scope with the input focus when it is overlapped with other objects which do not have the input focus.

### DETAILED DESCRIPTION OF PREFERRED EMBODIMENT

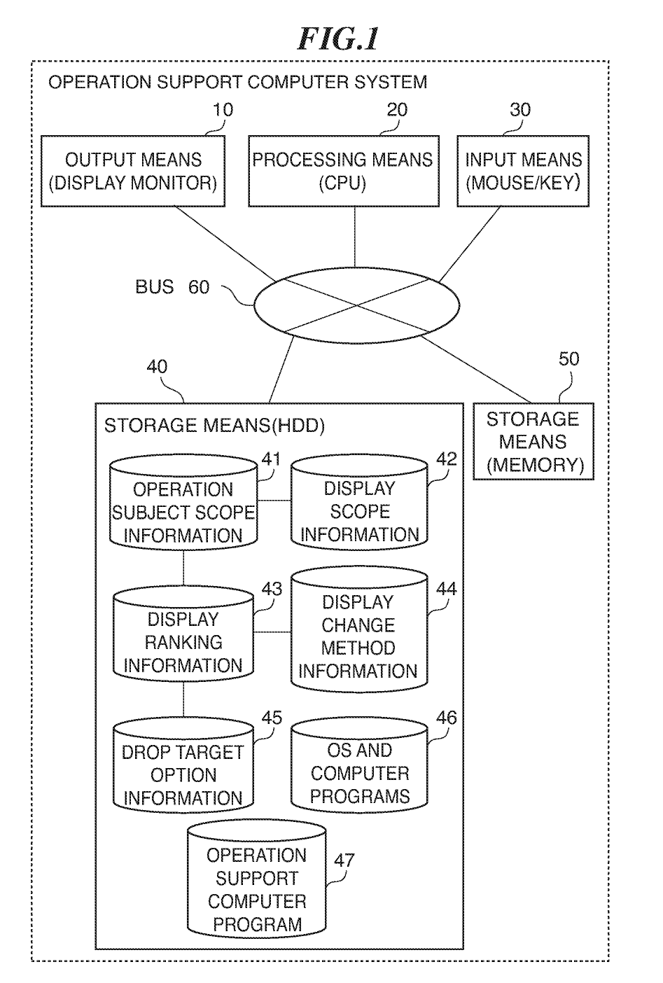

FIG. 1 shows a first embodiment of the present invention that is relating to the operational support computer system. The operational support computer system includes of an output means 10, a processing means 20, an input means 30 and storage means 40 and 50. These means (10-50) are connected to each other electrically through a bus 60 which enables to transmit information (transition of signal).

The output means 10, such as liquid crystal display (LCD) and Cathode Ray Tube (CRT) display device, is the output device that presents information to users of the operational support computer system. The processing means 20 is a computing device, such as Central Processing Unit (CPU), that works with the above stated devices. The input means 30, is an input device, such as mouse device and key board device that receive commands from users of the operational support computer system. The storage means 40 is an auxiliary storage device, such as a hard disk drive (HDD), which stores big amount of information. The storage means 50 is a main storage unit, such as main memory, that stores information that is the subject of the process operated by processing means 20. Bus 60 is a transmission path that transmits information within the operational support computer system.

The current invention of the operational support computer system may be operated within a local computer system such as personal computer. However, the current invention of the operational support computer system may be composed of multiple computer systems. As an example of system composed of multiple computers, but is not limited to, the output means 10 and the input means 30 may be a computer system at the client side and the processing means 20 and the storage means 40 and 50 may become a computer system at the server side. The bus 60 may be a broadband internet LAN.

(2) HDD works as a storage means 40 in FIG. 1 stores information, such as a operation subject scope information 41, a display scope information 42, a display ranking information 43, a display change method information 44, a drop target option information 45, an OS (Operating System) or a computer program 46, and an operation support program 47, in a database or file format.

CPU as a processing means 20 interprets and operates both data and program by loading information 41-47 stored in HDD, the storage means 40, into a memory device, the storage means 50. CPU as a processing means 20, also interprets 46, OS and other programs which are stored in HDD as a storage means 40, and the operational support computer program 47 after loading them into a memory device as a storage means 50. This exercises the current invention of the operation support process.

This present embodiment is understood that HDD, the storage means 40, initially stores the information 41-47, however, another possible embodiment can be storing the information 41-47 in the storage means 50 at the initial state.

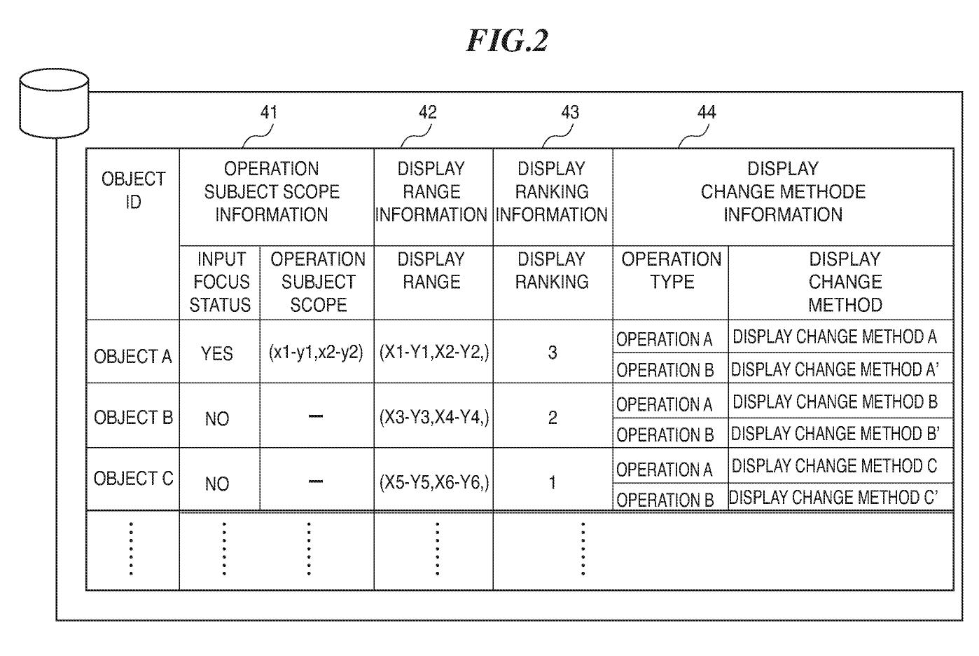

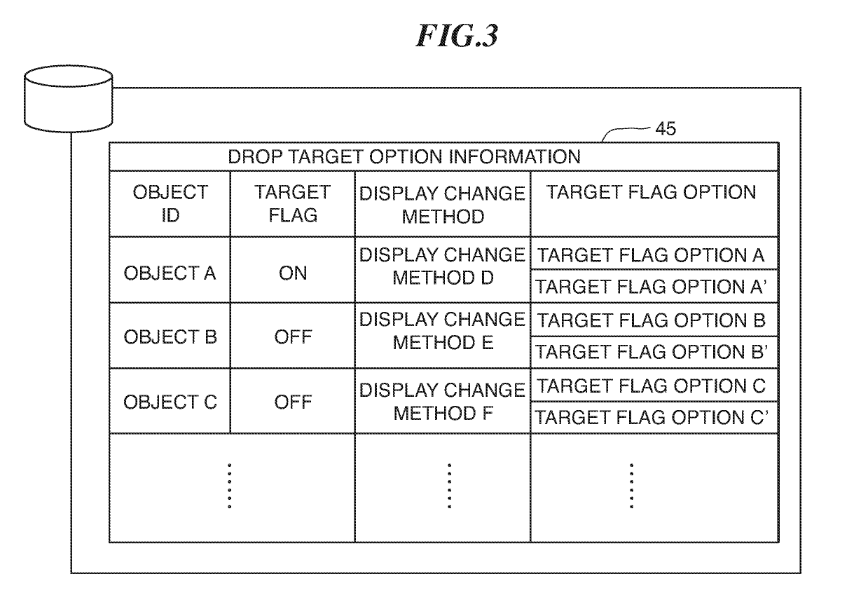

(3) FIG. 2 and FIG. 3 explain a data structure of information (41-47) stored in HDD, the storage means 40.

As shown in FIG. 2, the operation subject scope information 41, display range information 42, display ranking information 43, and display change method information 44 are stored in HDD, the storage means 40, which are corresponding to each other via an identical object identification (ID). Especially, the elements 41, 42, 43, and 44 are corresponding to each other via the object ID, and as having common object IDs enables to specify the content of the respective information.

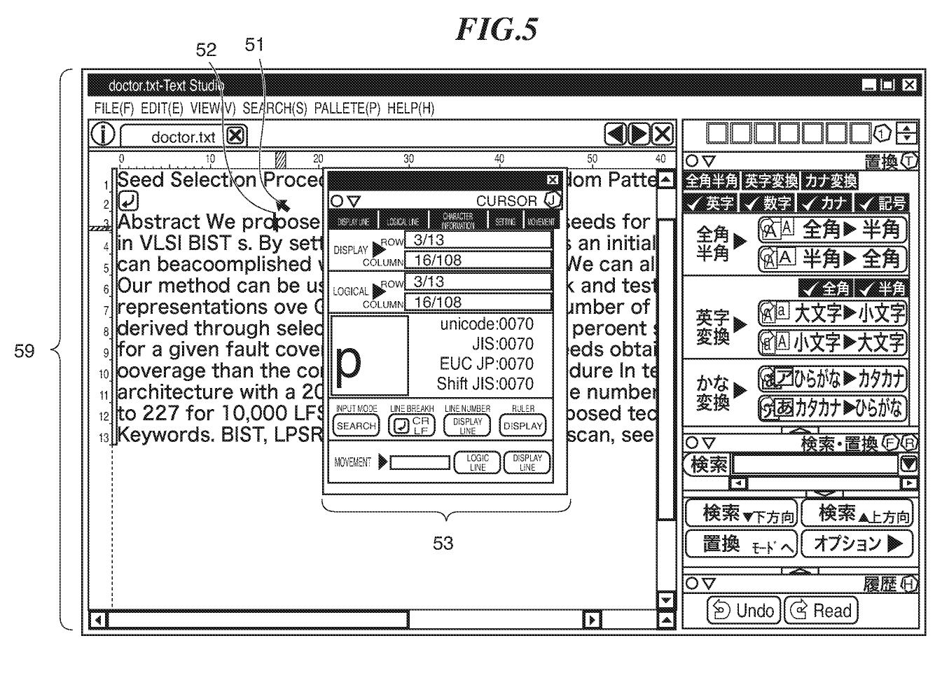

The operation subject scope information 41 is information corresponding the “input focus status” and “operation subject scope”. “Input focus status” is information showing whether each object has input focus or not. “Operation subject scope” is information of an area (pixel range) of operation subject scope presented on the display area, an output means 10. This area is a part of an object which has an input focus. However, when users move selected data, e.g. by drag-and-drop, “operation subject scope” may either be restricted to a display range for an object that has an input focus or to a display range for an operation subject scope. As a specific example of the operation subject scope, in a word-processing application software, may be two character spaces which include one character space for both sides of a cursor location, selected multiple character spaces, a mouse pointer when a selected data is in the process of relocation of data by drag-and-drop. Another specific example of “operation subject scope” in spreadsheet application software may be an area for a selected cell, area for multiple selected cells, area around a mouse pointer when selected cells are in the process of relocation. For example in FIG. 5, an example of monitor display as an output means 10, the operation subject scope is one space character where “p” occupies which is at the right hand side of the location which is pointed by a cursor 52 showing the input location of text is. In FIG. 2, an object whose “object ID” is “object A” has an input focus and of which operation subject scope can be specified as “(X1-y1, x2-y2)”. An object whose “object ID” is either “object B” or “object C”, own neither “input focus” nor “operation subject scope”. With an X-Y position of a coordinate space is able to specify a location of a range on the display area occupying the output means 10. That is, (x1-y1, x1-y2), which specifies the coordinate value as (left upside-right downside, left downside-right upside), shows a square space allocated on the display area on the output means 10. This is also applied to the display range information 42 shown in FIG. 2.

The display range information 42 is information that shows a range (pixel range) of each object that occupies the display area of the output means 10. When a “display range” overlaps with that of other objects, an object which is higher in the display ranking is given a priority to be shown in the display area. In FIG. 5, which is an example of a display area of an output means 10, “display range” of the tool window 53, is the area the tool window 53 is presented.

The display ranking information 43 is information of a ranking that determines which object should be given a priority in being displayed on the display area of an output means 10, when a display range of multiple objects overlap each other. In a specific example of FIG. 5, in which the output means 10, there is an area where the display range of tool window 53 overlaps with that of the main window 59 that has main text data. In this case, the tool window 53 is given priority to be displayed because the tool window 53 is higher than the main window 59 in the display ranking.

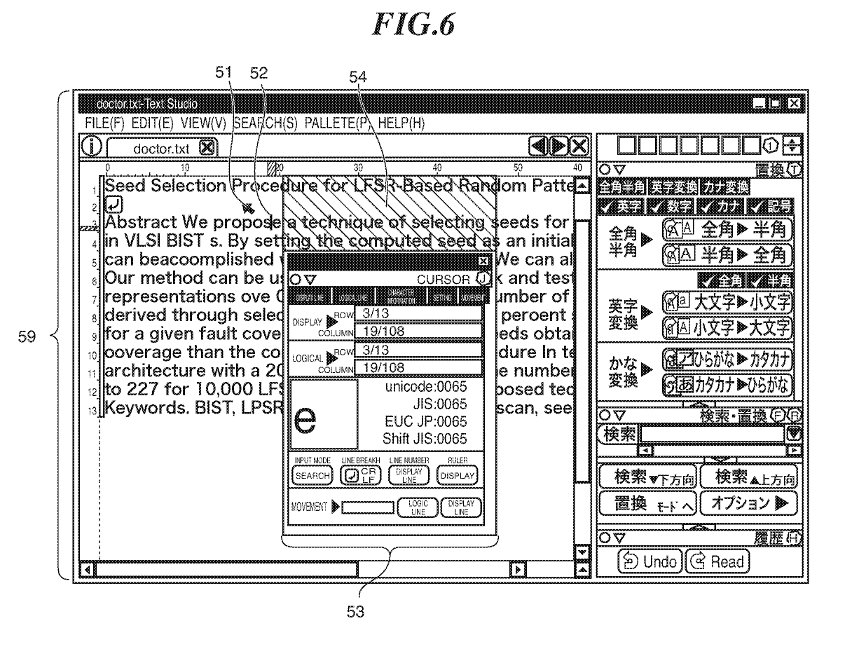

The display change method information 44 is information corresponds “operation type” and “display change method”. The operation type is information about types of operation performed by users. The display change method is information that is used to change the display method from the normal state presented in the display area of the output means 10. More specifically, it is a type of program that changes the display state of an object, in order not to obstruct the display of other objects. For example, the location of a display of the tool window 53 is different between FIGS. 5 and 6. This indicates that as a result of the change in the display method of tool window 53, the display states seen on FIG. 5 has changed into that of FIG. 6. The method of a display change can be varied depending on type of operations users' conduct because “type of operation” and “display change method” corresponds to each other. As a specific example of this is to differentiate between the display change method for moving the cursor pointer 51 and that for selecting the main text by adopting the method that is “move the display location of object” for the former and “make an object transparent” for the latter respectively.

(4) As shown in FIG. 2, the operation subject scope information 41, the display range information 42, the display ranking information 43, the display change method 44 are all corresponded to each other via “object ID”. This enables CPU, the processing means 20, to specify each object's input focus status, operation subject scope, display range, display ranking, operation type and display change method.

For example, object A has an “input focus”, whose “operation subject scope” is a square space which is expressed by coordinate (x1, y1) and (x2-y2) and whose “display area” is a square space which is expressed by coordinate (X1, Y1) and (X2-Y2). The “display ranking” of object A is third and the “operation type” is either A or B, whose program is specified as either display change method A or display change method A′ respectively.

In FIG. 2, object B and object C do not have an “input focus”; however, there is a possibility that both will have an input focus when a command that changes the “input focus status”. Even though a tool window generally does not receive an input from a keyboard, it is possible that it receives an input from other input device 30, such as a mouse device. Therefore, in FIG. 2, an object whose “object ID” is either objects A, B or C can be either a main window or tool window. For example, when object B in FIG. 2 with the display ranking shown as 43 has an input focus, under the condition that both objects B and C are tool windows, the display ranking of the object B should be lower than object C. If, then “operation subject scope” of object B overlaps with “display range” of object C, the “display method” of object C changes following to the display change method information 44 which is corresponded to object C.

(5) In FIG. 3 drop target option information 45 is information where the object ID, a “target flag”, “display change method” and a “target flag option” corresponded to each other. “Target flag” is information which indicates whether or not an object is a target object which indicates either ON or OFF. “Target object” indicates an object which selected data that is an operation subject will passed to. “Passing selected data” means that the selected data will become an operation subject of the object. In a specific example, when a toolbar is set as a target object, and multiple selected spaces of text data in the main text data presented in the main window are “selected data set as the operation subject”, the selected text data are passed to the tool bar by operating drag-and-drop. “Target flag option” is a picture data. There are at least two choices for “target flag option”. OFF is for turning off the target flag, and ON is for tuning on the target flag. In FIG. 3. target option A, target option B and target option C are target flags for ON and target option A′, target option B′ and target option C′ are those for OFF.

(6) As information is corresponded shown in FIG. 3, CPU (processing means 20) is able to specify “target flag,” “display change method” and “target flag option”. Information shown both in FIGS. 2 and 3 has an information item “Object ID”, which enables CPU (processing means 20) to specify information corresponding to each “Object ID”.

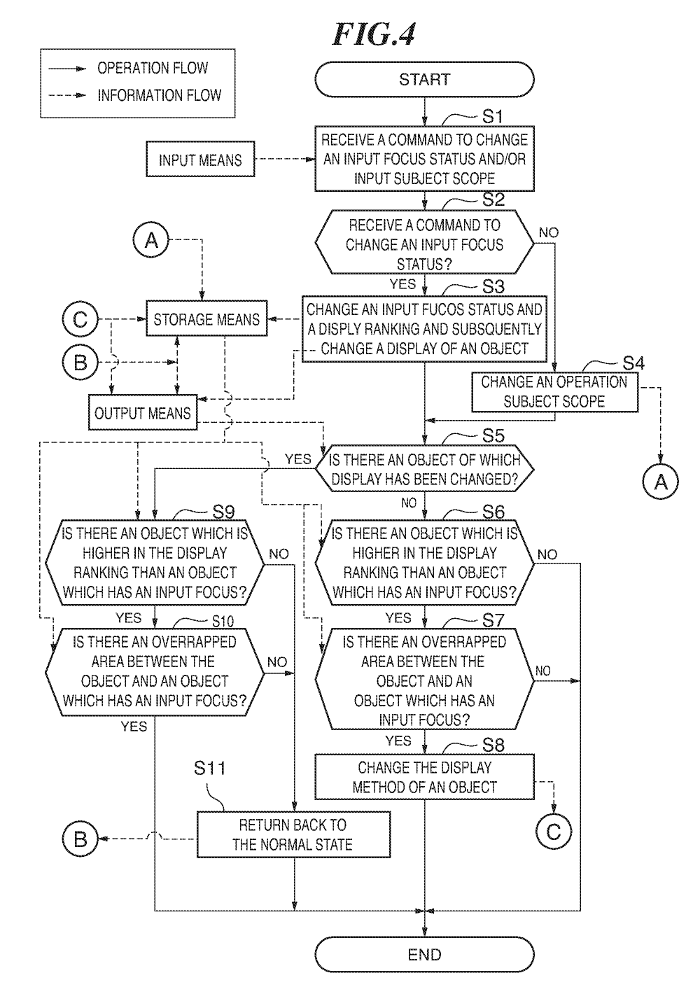

FIG. 4 is a flow chart of the operational support computer system regarding the present invention. This flow illustrates steps according to the invention.

(1) CPU, a processing means 20, receives a command of change either in the input focus status or the scope of the operation subject (51). An example of “command of change either in the input focus status or the scope of the operation subject” may be a command to pass an input focus from one object to another. More specifically, it means an electric signal that is sent out by an input means 30, such as mouse device or keyboard device. “Command of change in the input focus” includes an Object ID that comes to have an input focus after the signal is received. “Command of change in the scope of the operation subject” contains information of “operation subject scope” after the command may processed.

(2) Then, the processing means 20, CPU, judges whether it receives command about the input focus change. This is because when the command about the input focus change is received, the display ranking should also be changed.

(3) Then, at S2, when the processing means 20, CPU receives a command of changing the input focus change, CPU changes both the input status and display ranking stored in the storage means 40 and subsequently changes the display of the object at output means 10 (S3). More specifically, the input focus status in the operation subject scope information 41, which is recorded in the storage means 40, changes in accordance with the command of the change in the input focus. This is followed by the change in the display ranking contained in the display ranking information 43. Then, the display of each object presented in the output means 10 changes in accordance with the changes of the display ranking.

(4) Then, when the processing means 20, CPU, judges that command it received is the one to change the operation subject scope, unlike the one to change the input focus, the processing means 20 changes the operation subject scope (S4). More specifically, the operation subject scope, a part of the operation subject scope information 41, which is recorded in a storage means 40, will be changed in accordance with the command that orders to change the operation subject scope.

(5) Then, the processing means 20, CPU, judges whether or not there is any displayed objects of which display method has been changed (S5). This is because, if there is a displayed object of which display has been changed, there is a possibility that the display method may be changed back to the original state. This judgment at S5 is facilitated if the storage means 40 records data information, such as “display change method status” corresponding to each “Object ID”

(6) When the processing means 20, CPU, judges that there is no object that has changed its display method at S5, CPU judges whether there is an object which is higher in the display ranking than the object that has an input focus (S6). More specifically, CPU specifies an “Object ID” which is higher in the display ranking than the object that has an input focus based on the operation subject scope information 41 and display ranking information 43, which are memorized in the storage means 40.

(7) When the processing means 20, CPU, judges there is an object which is higher in the display ranking than the object that has an input focus, CPU seeks an overlap area between the display range of the said object and the operation subject scope of the object with an input focus (S7). More concretely, CPU judges whether there is an overlap between the display range corresponding to Object ID, which CPU specified at S5, and the operation subject scope of the object, which has the input focus in according to the operation subject scope information 41, and the display range information 42 stored in the storage means 40.

(8) The processing means 20, CPU, changes the display method of an object which is judged to be an object that overlaps the object with the input focus at S7. More specifically, the display of the operation subject scope of the object that has an input focus is not obstructed at the display area of the output means 10. When there is neither applicable object at S6 nor overlapped area at S7, the change of the display method operation, S8, will not be acted. This is because the display of the object which has an input focus is not obstructed by other objects. The judgment at S5 becomes easier, when the storage means 40 memorizes the change in the display method of an object processed at S8. This is exercised by the correspondence between an object ID and data items such as the display change method status. For example, the display change method status, which corresponds to “Object ID” of the object changed at S8, changes into “Yes”

(9) When the processing means 20, CPU, judges there is an object which has changed the display method at S5, CPU judges whether there is an object which is given a higher priority in the display ranking than the object with the input focus at S9. More specifically, similarly to S6, CPU judges whether or not there is an object ID which has a higher priority in the display ranking than the object with the input focus recorded in the storage means 40. This process is operated based on the operation subject scope information 41 and the display ranking information 43.

(10) When the processing means 20, CPU, judges there is an object with a higher priority in the display ranking than the object with the input focus at S9, CPU seeks if there is an overlapped area between the display range of object and the operation subject scope of the object which has an input focus (S10). More specifically, similarly to S7, CPU judges whether or not there is an overlapped area between the display area that corresponds to “Object ID” which is specified at S9 and the operation subject scope of an object which has an input focus based on the operation subject scope information 41 and the display range information 42 memorized in the storage means 40.

(11) When the processing means 20, CPU, judges there is neither an object applies to the description of S9 nor an overlapped area described in S10, CPU turns back the display method of the object which has been changed before into the normal display method S11. When CPU judges there is still an overlapped area at S10, the display method of the object whose display procedure has been changed remains to be changed. The judgment at S5 becomes easier, when the storage means 40 memorizes the change in the display method of the object processed at S11. That is, the “display change method status” that corresponds to “Object ID” of which the display method which has been changed back at S11 becomes “No”. This is exercised by corresponding an object ID to data item such as “display change method status”.

(12) As above, this present invention has a features that when the operation subject scope of an object with the input focus is overlapped by a display of other objects, the display method of the object changes appropriately without users' explicit command. This change prevents the display of the operation subject scope of an object with the input focus from being obstructed. Moreover, when either the input focus status or the operation subject scope changes, the display of the operation subject scope of the object which has an input focus will not be obstructed. Additionally, when the overlapped area between the object with an input focus and the operation subject scope of the object dissolves, the display method of the object which was changed in the proceeding process will return to the normal state without users' explicit command. This enables users to have a smooth operation under the multi-window interface because users do not have to give any commands to present a display of the operation subject scope of an object which has an input focus.

FIGS. 5-13 are diagram examples related to the present invention, which is the operational support computer system. FIGS. 5-13 represent a monitor display of the output means 10.

FIG. 5 illustrates an example of the normal state of the display area of the output means 10, which is before the action at S1 is operated by CPU. In FIG. 5, there are two objects. One is a main window 59 containing text data and another is a tool window 53. There are a cursor arrow 52 and a mouse pointer 51. A cursor arrow selects text data contained in a main window 59 and a mouse pointer 51 selects a specific location or range in the display area in a monitor display, the output means 10. In FIG. 5, “p” in “propose” is in the operation subject, which is located at the right side of a cursor arrow 52. A tool window 53 shows that “p” is the operation subject. In FIG. 5, all displayed objects are displayed in the normal state, the display method of any objects have not been changed.

FIG. 6 represents a specific example of display area presented in the monitor display, the output means 10, after a process at S8. This is resulted from the process where CPU, the processing means 20 receives a command to change the operation subject scope at S1, changes the operation subject scope at S4, makes a “NO” judgment at S5, makes “YES” judgment both at S6 and S7, and changes the display method of a tool window at S8. This shows that the cursor arrow has moved toward right for three character spaces, which leads the change of the operation subject scope. The current operation subject scope is on “e” in “propose”, which are seen from the tool window 53. As a result, the display range of “e” in “propose” overlaps with the tool window 53, which leads to a change in the display method of the tool window 53, moving downward. The display range where the tool window 53 used to be located, there was a frame display 54 which presents the display range of the trace of the tool window 53. The operation subject scope covers the whole square space that is allocated for one character space. That is, the operation subject scope for “e” in “propose” is not only the colored area which presents “e”, but also the square area for one character space. The character “e” itself does not overlap with the tool window 53; however, the one character space which is the operation subject scope overlaps with the display area of the tool window 53.

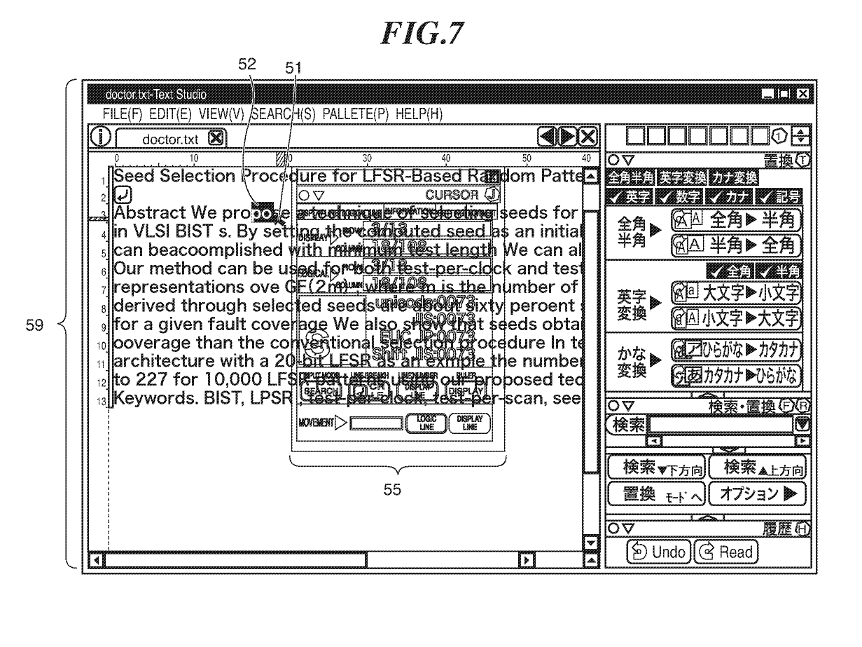

FIG. 7 illustrates a specific example of the display area of the display monitor when the display method of a tool window 53 changes at S8. This change of the output means 10 occurs when CPU, the processing means 20, receives a command that changes the operation subject scope at S1 which leads to a command to select a subject scope data, subsequently changes the operation subject scope at S4 selects “NO” judgments at S5, and then selects “YES” judgments both at S6 and S7. A “command to select a subject scope data” indicates a signal sent from a mouse tool, the input means 30. The signal is sent when data is selected to be cut or copy during the process of the drag action of drag-and-drop operation. That is, all text data after “p” becomes an operation subject scope of the text data, when the drag operation is processed by the mouse pointer 51 starts from the second “p” in the “propose”. All text data following to the second “p” are under an operation subject scope as there is a possibility that they are to be selected data even before it becomes selected data. This causes an overlapped area between all main text data after “p” and a tool window 53. Then, the display method of the tool window 53 has changed into transparent. As a result, users are able to recognize the main text data on the main window 59. The tool window 53 becomes transparent, as 55 on the display area of the output means 10.

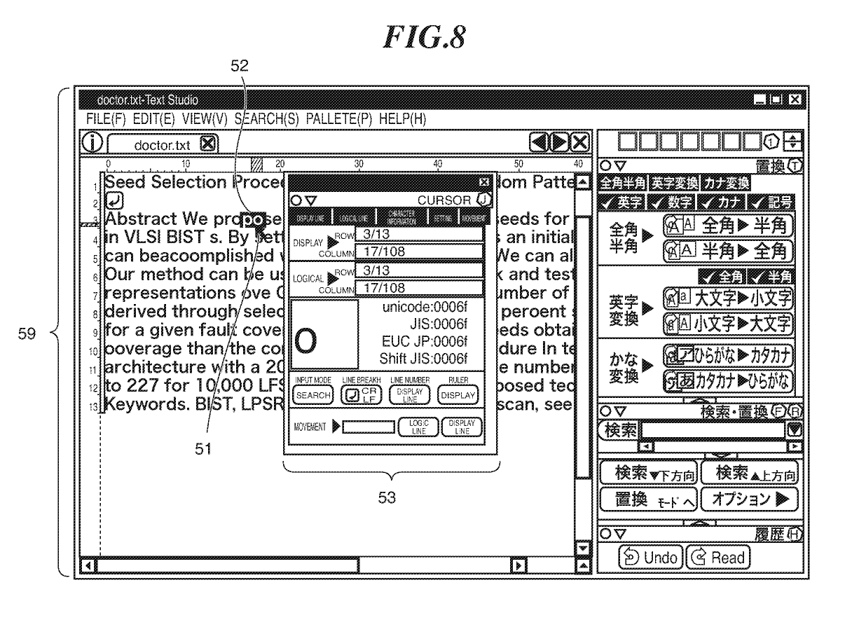

FIG. 8 illustrates a specific example of the display area of the display monitor after selecting data stated above which FIG. 7 presents. The drag action of a mouse pointer 51 stared from the second “p” in “propose” is dropped while “p” and “o” on “p”'s immediate right are selected. After the drop action is made, the scope for selected data is confirmed. That is, only a character space for the selected data “p” and “o” becomes an operation subject scope, the whole text data following to “p” are no longer under the operation subject scope, which is the case in FIG. 7. Furthermore, this change in the operation subject scope dissolves the overlapped area between the operation subject scope and a tool window 53, which leads to CPU, the processing means 20, operates the said S11, changing back the display method of the tool window 53 to the normal state.

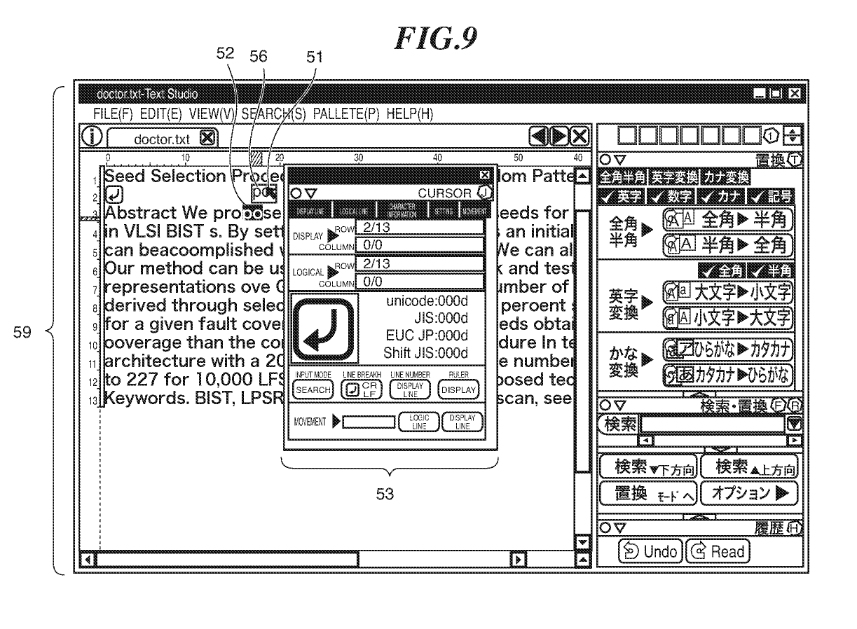

FIG. 9 illustrates a display area of the monitor display, while CPU processes the operation of deciding the destination of the selected data “p” and “o” selected in FIG. 8. The operation subject scope may be a range where the mouse pointer 51 indicates and/or the range of the selected data display 56, which indicates that the selected data, “p” and “o”, are in the process of relocation. In FIG. 9, the display method of the tool window 53 stays as normal as there is no overlapped area between the operation subject scope and the tool window 53.

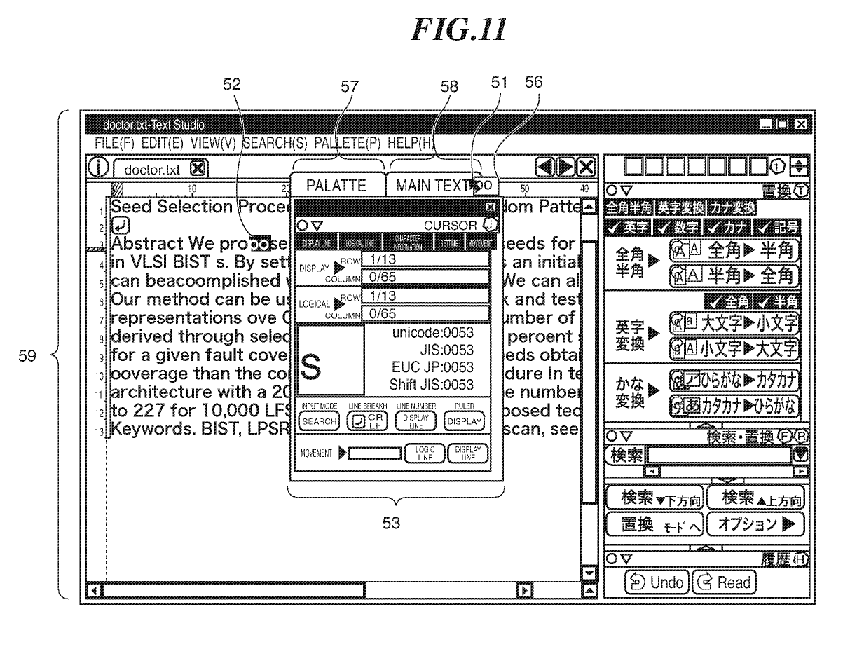

FIG. 11, the drag operation starting from the selected data “p” and “o” of the mouse pointer 51 has been continued from FIG. 9. The drop operation which decides a destination of the relocation of the selected data has not been operated. The operation subject scope may be either a range where the mouse pointer 51 indicates and/or a range where selected data display 56 which shows that the text data “p” and “o” are in the process of relocation. In FIG. 11, there is an overlapped area between the operation subject scope and the display range of the target flag option 58. More specifically, CPU, the processing means, specifies “object ID” and “target flag” corresponding to the target flag option 58 which is selected by the mouse pointer 51. The display of the target flag changes into the display specified by the content of target flag option 58. In this example, the target flag option 58 indicates that content of “target flag” changes into “OFF”.

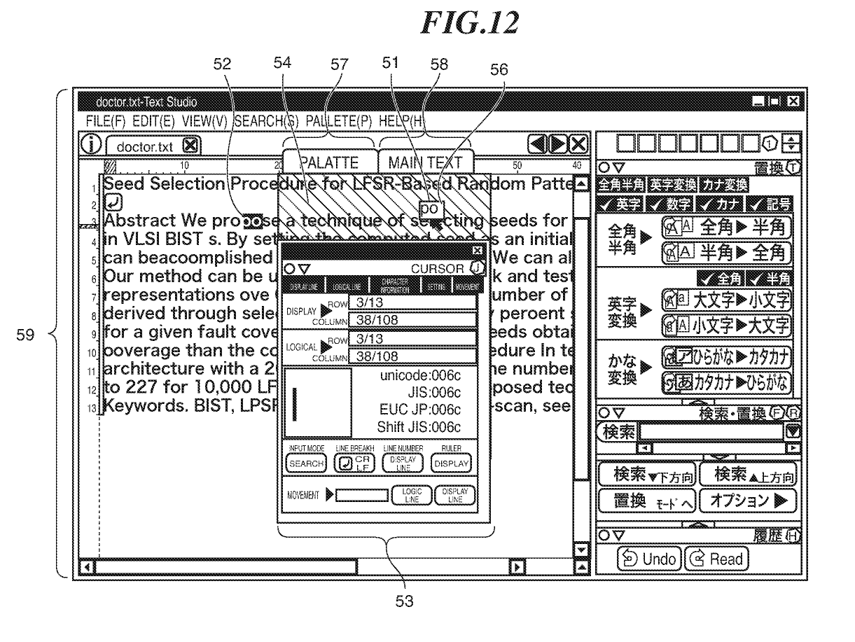

FIG. 12, the drag operation deciding the destination of the selected data “p” and “o” has been continued from FIG. 9. The mouse pointer 51 is on the drag action from the character space of the selected data, “p” and “o”. The drop action which decides the destination has not been operated. The operation subject scope may be either a range where the mouse pointer indicates and/or a range where selected data display 56 which shows that the text data “p” and “o” are in the process of relocation. In FIG. 12, the display method of the tool window 53 was moved downward and a frame display 54 which demonstrates the display range of the tool window 53 before it was relocated. This is because the target content of tool window 53 is set as “OFF” and there is an overlapped area between the operation subject scope and the tool window 53. More specifically, CPU, the processing means 20, judges whether there is necessity to change the display method for the tool window 35. That is, CPU, specifies “Object ID” corresponding to the tool window 53, based on the subject operation scope information 41, the display range information 42, and the drop target option information 45, which leads to the said judgment on the display change method in accordance with “target flag” and “display change method” corresponding to the said “object ID”. For example, when “target flag” is set as “OFF”, the display change shown as a content of “display change method” is operated, and when the “target flag” is set as “ON”, the display change shown as a content of “display change method” is not operated.

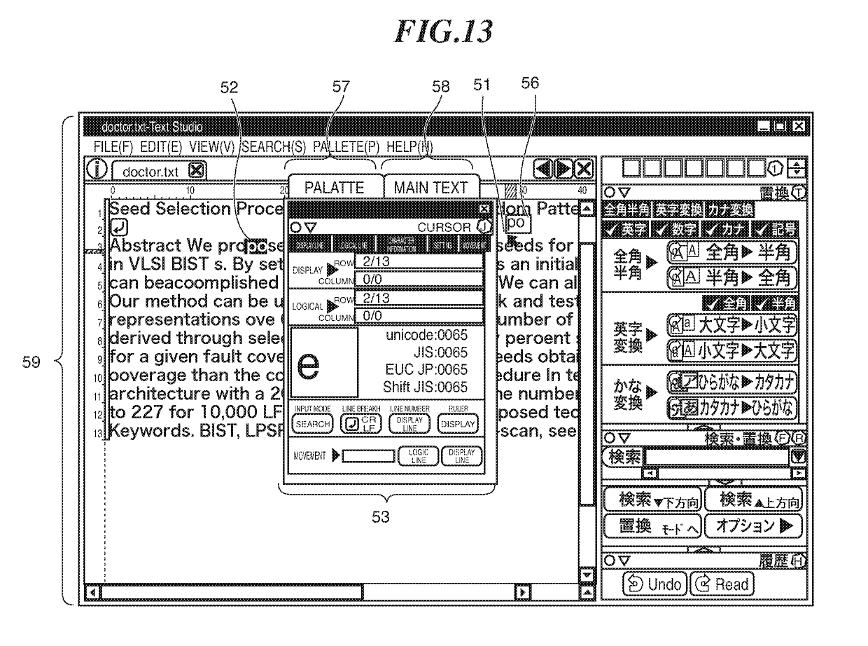

In FIG. 13 the drag action, “p” and “o” selected by the mouse pointer 51, has been continued from FIG. 9. The drop action deciding the destination has not been operated. The operation subject scope maybe a range a mouse pointer 51 indicates or the selected data display 56 which shows that the text data “p” and “o” are in the process of relocation. As there is no overlapped area between the operation subject scope and a display range of the tool window 53, the display status of the tool window 53 which was moved to the downward moves back to normal in FIG. 13. More specifically, CPU, the processing means 20, changes the display procedure of the tool window 53 back to normal. This is operated by specifying “Object ID” of the tool window 53, which does no longer overlap with the operation subject scope based on the operation subject scope information 41 and the display range information 42, which are stored in the storage means 40.

As a result of a series of operations, users only have to move the mouse pointer 51 to an appropriate location when deciding which object to be a target object or not. This improves the efficiency of operation during the relocation of the selected data compared to existing method.

FIG. 1 is a block overall view of the configuration diagram for the operational support computer system.

FIG. 2 is a data structural view of the respective information 41-44 stored in a storage means 40.

FIG. 3 is a diagrammatic illustration of the structure of the drop target option information 45 stored in a storage means 40.

FIG. 4 is a flowchart of the support process operation by a processing means 20.

FIG. 5 is a view of the monitor display example 1 showing the respective objects presented during the operation support process.

FIG. 6 is a view of the monitor display example 2 showing the respective objects presented during the operation support process.

FIG. 7 is a view of the monitor display example 3 showing the respective objects presented during the operation support process.

FIG. 8 is a view of the monitor display example 4 showing the respective objects presented during the operation support process.

FIG. 9 is a view of the monitor display example 5 showing objects presented during the operation support process.

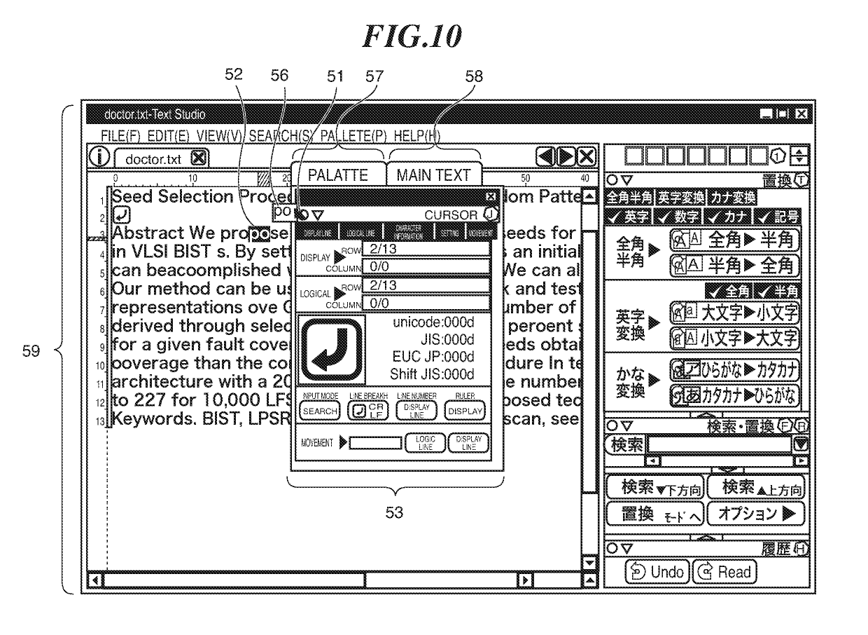

FIG. 10 is a view of the monitor display example 6 showing objects presented during the operation support process.

FIG. 11 is a view of the monitor display example 7 showing objects presented during the operation support process.

FIG. 12 is a view of the monitor display example 7 showing objects presented during the operation support process.

FIG. 13 is a view of the monitor display example 9 showing objects are presented during the operation support process.

What is claimed is:

1. A computer program for a computer system, comprising an information storage means, an information processing means, an output means displaying information to users, and an input means receiving a command from users,
said computer program operates as an operational support computer program when the output means displays multiple objects in a display area while the user operates one of aforementioned objects having an input focus,
said the storage means stores:
operation subject scope information, which presents a display range of the operation subject of the processing means presented in a display area of a monitor display by corresponding an object ID to an input focus status and an operation subject scope;
display range information, which presents a display range of an object on a display area of an output means by corresponding an object ID to a display range;
display ranking information, which indicates ranking of an object in display on the display area of output means;
and display change method information, which describes a method how to change display of an object shown in the display area by corresponding an object ID to a display change method,
said processing means:
(1) receives a command, which is given by the input means, of an input focus status and/or the change of the operation subject scope included in the operation subject scope information stored in the storage means;
(2) changes the input focus status and/or the operation subject scope, which are stored in the storage means as a part of the operation subject scope information, based on the command received, subsequently, changes the display ranking included in a part of display ranking information, which changes the display of objects presented in the display area when an input focus status has been changed;
(3) selects an object which is higher in the display ranking than an object having an input focus, based on the operation subject scope information and the display ranking information and
judges whether or not there is an area in which an operation subject scope of an object having an input focus overlaps with a display range of the selected object based on the display change method information and the display range information;
(4) prevents from obstructing the display of an operation subject scope of the object having an input focus, on the monitor of the output means by changing the display method of the object based on the display change method information, if there are any applicable objects as a result of (3);
and (5) terminates the operation of display change stated in (4), when the process of (1) and (2) have solved the state (3).

2. A computer program for a computer system, comprising an information storage means, an information processing means, an output means displaying information to users, and an input means receiving a command from users,
said computer program operates as an operational support computer program when the output means displays multiple objects in a display area while the user operates one of aforementioned objects having an input focus,
said the storage means stores:
operation subject scope information, which presents a display range of the operation subject of the processing means presented in a display area of a monitor display by corresponding an object ID to an input focus status and an operation subject scope;
display range information, which presents a display range on a display area of the output means by corresponding an object ID to a display range;
display ranking information, which indicates ranking of an object in display on the display area of output means;
and display change method information, which describes a method how to move a location of a display of an object shown in the display area by corresponding an object ID to a display change method,
said processing means:
(1) receives a command, which is given by an input means, of an input focus status and/or the change of the operation subject scope included in the operation subject scope information stored in the storage means;
(2) changes the input focus status and/or the operation subject scope, which are stored in the storage means as a part of the operation subject scope information, based on the command received, subsequently, changes the display ranking included in a part of display ranking information, which changes the display of objects presented in the display area when an input focus status has been changed;
(3) selects an object which is higher in the display ranking than an object having an input focus, based on the operation subject scope information and the display ranking information and
judges whether or not there is an area in which an operation subject scope of an object having an input focus overlaps with a display range of the selected object based on the display change method information and the display range information;
(4) prevents from obstructing the display of an operation subject scope of the object having an input focus on the monitor of the output means by moving the display range of other objects based on the display change method information, if there are any applicable objects as a result of (3);
and (5) terminates the operation of display change stated in (4), when the process of (1) and (2) have solved the state (3).

3. A computer program for a computer system, comprising an information storage means, an information processing means, an output means displaying information to users, and an input means receiving a command from users,
said computer program operates as an operational support computer program when the output means displays multiple objects in a display area while the user operates one of aforementioned objects having an input focus,
said the storage means stores:
operation subject scope information, which presents a display range of the operation subject of the processing means presented in a display area of a monitor display by corresponding an object ID to an input focus status and an operation subject scope:
display range information, which presents a display range on a display area of an output means by corresponding an object ID to a display range:
display ranking information, which indicates ranking of an object in display on the display area of output means:
and display change method information, which describes a method allowing contents of an object ranked lower in the display ranking to be presented by changing a display of an object which is at the front into transparent by corresponding an object ID to a display change method,
said processing means:
(1) receives a command, which is given by an input means, of an input focus status and/or the change of the operation subject scope included in the operation subject scope information stored in the storage means:
(2) changes the input focus status and/or the operation subject scope, which are stored in the storage means as a part of the operation subject scope information, based on the command received, subsequently, changes the display ranking included in a part of display ranking information, which changes the display of objects presented in the display area when an input focus status has been changed:
(3) selects an object which is higher in the display ranking than an object having an input focus, based on the operation subject scope information and the display ranking information and
judges whether or not there is an area in which an operation subject scope of an object having an input focus overlaps with a display range of the selected object based on the display change method information and the display range information:
(4) prevents from obstructing the display of an operation subject scope of the object having an input focus on the monitor of the output means through the other object by changing the other object into transparent based on the display change method information, if there are any applicable objects as a result of (3):
and (5) terminates the operation of display change stated in (4), when the process of (1) and (2) have solved the state (3).

4. A computer program for a computer system, comprising an information storage means, an information processing means, an output means displaying information to users, and an input means receiving a command from users,
said computer program operates as an operational support computer program when the output means displays multiple objects in a display area while the user operates one of aforementioned objects having an input focus,
said the storage means stores:
operation subject scope information, which presents a display range of the operation subject of the processing means presented in a display area of a monitor display by corresponding an object ID to an input focus status and an operation subject scope:
display range information, which presents a display range on a display area of an output means by corresponding an object ID to a display range:
display ranking information, which indicates ranking of an object in display on the display area of output means:
and display change method information, which describes a method both how to move a display range of an object presented on a display monitor and a display range in which the relocated object was presented before its relocation in order to present a display of an object ranked lower in display ranking by corresponding a display change method to each of an object ID in the storage means,
said processing means:
(1) receives a command, which is given by an input means, of an input focus status and/or the change of the operation subject scope included in the operation subject scope information stored in the storage means:
(2) changes the input focus status and/or the operation subject scope, which are stored in the storage means as a part of the operation subject scope information, based on the command received, subsequently, changes the display ranking included in a part of display ranking information, which changes the display of objects presented in the display range when an input focus status has been changed:
(3) selects an object which is higher in the display ranking than an object having an input focus, based on the operation subject scope information and the display ranking information and,
judges whether or not there is an area in which an operation subject scope of an object having an input focus overlaps with a display range of the selected object based on the display change method information and the display range information:
(4) prevents from obstructing the display of an operation subject scope of the object having an input focus on the monitor of the output means both by moving the display range of other objects based on the display change method information and by presenting the display area of the object in which the relocated object was presented before the relocation:
and (5) terminates the operation of display change stated in (4), when the process of (1) and (2) have solved the state (3).

5. A computer program for a computer system, comprising an information storage means, an information processing means, an output means displaying information to users, and an input means receiving a command from users,
said computer program operates as an operational support computer program when the output means displays multiple objects in a display area while the user operates one of aforementioned objects having an input focus,
said the storage means stores:
operation subject scope information, which presents a display range of the operation subject of the processing means presented in a display area of a monitor display by corresponding an object ID to an input focus status and an operation subject scope:
display range information, which presents a display range on a display area of an output means by corresponding an object ID to a display range:
drop-target-option information allowing a user to decide whether or not an object becomes a target object, which is an object to which selected data are passed to, by corresponding a target flag option consisting of a set of picture data, object ID, and a target flag:
and display change method information describing method how to change a display range of an object presented in the display area on the output means,
said processing means:
performs (1)-(4) below while a process of moving the selected data included in an object having an input focus, and to completes the display operation (3) when a destination operation on the selected data completes.
(1) receives a command, which is given by an input means, to change the operation subject scope included in the operation subject scope information stored in the storage means, and subsequently changing the operation subject scope included in the subject scope information:
(2) judges whether or not there are any objects whose display range overlaps with the display range of an operation subject scope based on the operation subject scope information and the display range information:
(3) displays the target flag option information of the applicable object as a result of the judgment (2) in the display area of the output means and changes the display method of the object based on the drop target option information when the target flag option is set as off and disenabling to select the object as a target object, a destination object of a selected data:
(4) changes the display of the target flag included in drop target information based on the target flag option selected by a pointer into either on or off following to the selection made by users.

6. A computer program for a computer system, comprising an information storage means, an information processing means, an output means displaying information to users, and an input means receiving a command from users,
said storage means memorizes the process stated in the claim either 1, 2, 3, 4, or 5 and the operational support computer program, and the processing means to operate the stated individual process.
